(19) United States
(12) Patent Application Publication
(10) Pub. No.: US 2023/0308887 A1
(43) Pub. Date: Sep. 28, 2023

(54) Wireless Mesh System and Method Supporting Local Emergency Network Access

(71) Applicant: 6Harmonics Inc., Ottawa (CA)

(72) Inventor: Shinguan Wu, Ottawa (CA)

(21) Appl. No.: 18/189,192

(22) Filed: Mar. 23, 2023

Related U.S. Application Data
(60) Provisional application No. 63/323,165, filed on Mar. 24, 2022.

(51) Int. Cl. H04W 16/14; H04L 43/10

(52) U.S. Cl. CPC H04W 16/14; H04L 43/10

(57) ABSTRACT

A system having a network communication interface for communicatively coupling via the Internet also includes a wireless transceiver for data communication via a frequency within a television white space band. The system has a battery for powering the wireless transceiver and a dedicated power source for charging the battery. Within the system is a memory for storing data relating to a peer transceiver. The stored data is for use in determining an operational state of the peer transceiver. The wireless transceiver of the system, in the absence of external power, operates to transmit data wirelessly supporting digital data communication.

### FIELD OF THE INVENTION

The invention relates to wireless networking and more particularly to wireless networks formed within television white space bands.

### BACKGROUND

In many applications it would be advantageous to have a very robust backup communication network. For example, in Ottawa, Canada, there are many high reliability services wherein a wired data communication system is provided with a backup connection to the Internet via a microwave point to point emergency link. Unfortunately, microwave point to point communication links have many drawbacks such as line of sight issues, weather dependency issues, antennas misalignment issues, power consumption issues, and infrastructure/construction issues, high cost issues for both CAPEX and OPEX. Microwave point to point connections also act as a second single point of failure. These problems make microwave line of sight of limited resiliency and require frequent monitoring, testing and remediation to ensure availability.

For example, if a building is constructed or a tree grows directly in the line of sight, communication is compromised. Such an occurrence is neither uncommon nor hard to foresee (in general terms). Unfortunately, one cannot stop nature or construction, which makes microwave point to point backup networks costly to install and manage. Further, they are quite vulnerable to intentional “failure” through direct attack or by attacking the communication link they rely upon.

It would be advantageous to provide a more robust, less failure prone, lower maintenance solution for communication.

### SUMMARY

In accordance with an embodiment there is provided a method comprising: providing a first transceiver for transmitting and receiving signals within a television portion of the spectrum, the transceiver for operating within the television white space band; operating the first transceiver in a standby mode wherein at intervals the transceiver transmits within the television white space band a heartbeat signal and awaits a heartbeat acknowledgement signal within the television white space band; and upon receiving a heartbeat acknowledgement signal in response to a transmitted heartbeat signal, performing one of storing an indication of a transceiver from which the heartbeat acknowledgement signal is received and transmitting an indication of a transceiver from which the heartbeat acknowledgement signal is received to a remote server.

In accordance with an embodiment there is provided a system comprising: a first transceiver for operation within the television white space band for transmitting and receiving signals within the television whitespace band; a heartbeat signal circuit for transmitting at intervals a heartbeat signal from the first transceiver and for receiving heartbeat acknowledgement signals in response thereto; and a heartbeat acknowledgement signal circuit for in response to receiving a heartbeat signal transmitting a heartbeat acknowledgement signal, the heartbeat acknowledgement signal including data for identifying the first transceiver.

In accordance with an embodiment there is provided a method comprising: providing a first transceiver for transmitting and receiving signals within a television portion of the spectrum, the transceiver for operating within the television white space band; operating the first transceiver in a standby mode wherein at intervals the transceiver transmits within the television white space band a heartbeat signal and awaits a heartbeat acknowledgement signal within the television white space band; and upon receiving a heartbeat acknowledgement signal in response to a transmitted heartbeat signal, performing one of storing an indication of a transceiver from which the heartbeat acknowledgement signal is received and transmitting an indication of a transceiver from which the heartbeat acknowledgement signal is received to a remote server.

In accordance with an embodiment there is provided a method comprising: providing a first transceiver for communicating via TVWS, the first transceiver communicating with N terminals disposed within a first area of transmission of the first transceiver; providing a second other transceiver having a second area of transmission at least partially overlapping the first area of transmission; determining terminals within an area overlapped by the first area of transmission and the second area of transmission; and apportioning the terminals for communication with one of the first transceiver and the second other transceiver in accordance with bandwidth available at each of the first transceiver and the second other transceiver and allocated bandwidth for each terminal.

In some embodiments, the terminals are apportioned based on geographic proximity and wherein the power level of transmission of the first transceiver is adjusted to limit interference with the second other transceiver.

In accordance with an embodiment there is provided a method comprising: providing a first transceiver for communicating via TVWS, the first transceiver communicating with N terminals disposed within a first area of transmission of the first transceiver; providing a second other transceiver having a second area of transmission at least partially overlapping the first area of transmission; when transmissions from the first transceiver are interrupted, disabling the first transceiver and apportioning bandwidth among the N terminals for communication with the second other transceiver in accordance with bandwidth available at each of the N terminals.

In accordance with an embodiment there is provided a method comprising: providing a first transceiver for communicating via TVWS, the first transceiver communicating with N terminals disposed within a first area of transmission of the first transceiver; providing a second other transceiver for communicating wirelessly with a satellite and supporting data communication therewith; wherein communications received from the satellite transceiver are directed to a local area wireless network via the first transceiver.

In some embodiments, controlling data bandwidth to each of the N terminals is performed independently to support different levels of service.

In some embodiment, a second other transceiver is provided, wherein the communication signals received from the satellite transceiver are directed to the first transceiver via the second other transceiver.

In some embodiments, a third other transceiver is provided, wherein the communication signals received from the satellite transceiver are directed to the first transceiver via one of the second other transceiver and the third other transceiver, wherein in the event of a failure of the second transceiver, the signal remains transmissible between the satellite transceiver and the first transceiver via the third transceiver.

In some embodiments, on-demand network bandwidth is provided via a wireless data communication signal within a television white space spectrum, the on-demand network bandwidth provided to a receiver terminal in response to a request from the terminal for network bandwidth and an associated payment.

In accordance with an embodiment there is provided a method comprising: providing a first transceiver for communicating via TVWS, the first transceiver communicating with N terminals disposed within a first area of transmission of the first transceiver; providing a second other transceiver for communicating wirelessly with a satellite and supporting data communication therewith; wherein communications received from the satellite transceiver are directed to a local area wireless network via the first transceiver; providing a first wireless transceiver coupled to a WAN and for transmitting within a frequency spectrum associated with television white space; providing a first terminal for receiving wireless transmissions within the frequency spectrum associated television white space; transmitting a request from the terminal to the first transceiver requesting for one of a short duration of network access and a predetermined amount of network bandwidth; in response to the request from the terminal, transmitting to the terminal a cost of fulfilling the request; and the transceiver providing to the terminal the requested network bandwidth.

In accordance with an embodiment there is provided a method comprising: providing a first transceiver for communicating via TVWS, the first transceiver communicating with N terminals disposed within a first area of transmission of the first transceiver; and at intervals detecting signals received from each of the N terminals and when a signal from one of the N terminals is other than received, notifying a server of a potential terminal failure.

In accordance with an embodiment there is provided a method comprising: providing a first transceiver for communicating via TVWS, the first transceiver communicating with N terminals disposed within a first area of transmission of the first transceiver; and at intervals detecting signals received from each of the N terminals and when a signal from none of the N terminals is received, notifying a server of a potential transceiver failure.

In accordance with an embodiment there is provided a system comprising: a network communication interface for communicatively coupling via the Internet; a wireless transceiver for data communication via a frequency within a television white space band; a battery for powering the wireless transceiver; a dedicated power source for charging the battery; a memory for storing data relating to a peer transceiver, the data for use in determining an operational state of the peer transceiver; and wherein, in the absence of external power, the wireless transceiver operates to transmit data wirelessly supporting digital data communication.

### BRIEF DESCRIPTION OF THE DRAWINGS

Exemplary embodiments of the invention will now be described in conjunction with the following drawings, wherein similar reference numerals denote similar elements throughout the several views, in which:

FIG. 1 is a simplified diagram of a communication network;

FIG. 2 is a simplified diagram of a communication network with a backup communication link;

FIG. 3 is a simplified diagram of a remote location having houses very spread out;

FIG. 4 is a simplified diagram of a plurality of TVWS transceivers spread across a vast area and supporting robust network connectivity;

FIG. 5 is a simplified diagram of a plurality of TVWS transceivers spread across a vast area and supporting robust network connectivity even when one fails;

FIG. 6 is a simplified diagram of a plurality of TVWS transceivers spread across a vast area and supporting robust network connectivity and able to reconfigure when one or more transceivers fail;

FIG. 7, is a simplified diagram of a network similar to that of FIG. 4, but with each TVWS transceiver connected to a WAN in the form of the Internet via satellite communications;

FIG. 8 shows a single transceiver connected to a WAN in the form of the Internet via satellite communications;

FIG. 9 is simplified diagram showing a transceiver coupled for receiving wireless communications and for wirelessly providing networking to a local community;

FIG. 10 is another simplified diagram showing a transceiver coupled for receiving wireless communications and for wirelessly providing networking to a local community;

FIG. 11 is a simplified diagram of a self-configuring network communication transceiver unit;

FIG. 12, shown is a simplified diagram of a single transceiver communicatively connected to a WAN in the form of the Internet for providing paid Internet access via TVWS communications;

FIG. 13 is a simplified diagram of a self powered and self contained TVWS networking node;

FIG. 14 is a simplified flow diagram of a process for supporting transceiver stand-by mode of operation; and

FIG. 15 is a simplified flow diagram for a self-configuring network comprising transceivers in standby mode reconfiguring in response to data received from a central network controller.

### DETAILED DESCRIPTION OF EMBODIMENTS

The following description is presented to enable a person skilled in the art to make and use the invention and is provided in the context of a particular application and its requirements. Various modifications to the disclosed embodiments will be readily apparent to those skilled in the art, and the general principles defined herein may be applied to other embodiments and applications without departing from the scope of the invention. Thus, the present invention is not intended to be limited to the embodiments disclosed but is to be accorded the widest scope consistent with the principles and features disclosed herein.

### Definitions

TVWS (or TV white space, or television white space) is a portion of the wireless communication spectrum including parts of the VHF and UHF bands initially allocated for television broadcast transmission and spacing therebetween and now unused in some areas, some different TVWS existing in some different geographic areas.

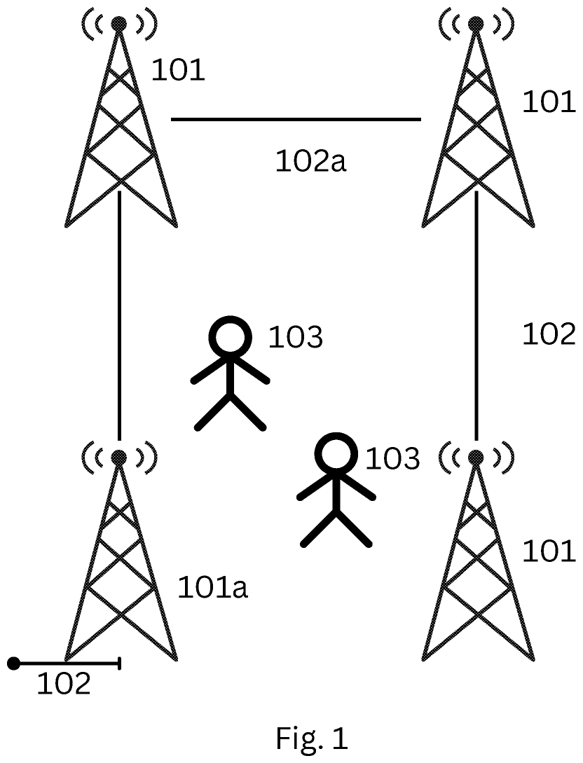

Referring to FIG. 1, shown is a typical communication network. Here, a plurality of nodes 101, 101a are coupled to a wide area network in the form of the internet via a fibre optic connections 102, 102a. Each node supports a wireless network thereabout for users 103 of the service. The network provides communication to each wireless customer so long as each node is operational and so long as communication to and from each node is uninterrupted. As shown, if a break occurs in fibre optic cable 102a, then users to the right of the break all lose connectivity to the wide area network. Analogously, if node 101a fails, then users who are wirelessly communicating via node 101a lose their connectivity.

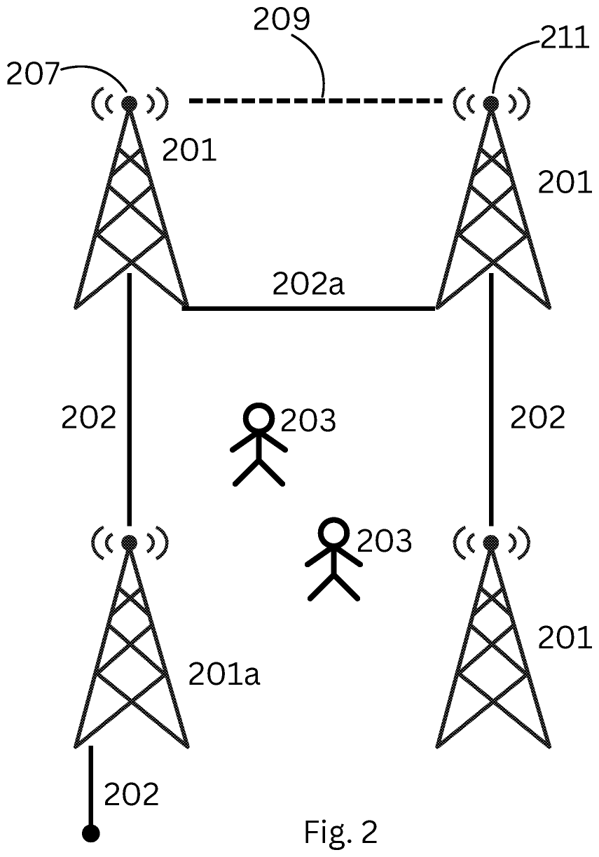

Referring to FIG. 2, shown is a typical communication network with a generator powered backup connection. Here, a plurality of nodes 201, 201a are coupled to a wide area network in the form of the internet via fibre optic connections 202, 202a. Each node supports a wireless network thereabout for users 203 of the service. The network provides communication to each wireless customer so long as each node is operational and so long as communication to and from each node is uninterrupted. The network further includes a backup microwave point to point link formed by transceiver 207 and transceiver 211. Between the transceivers is communicated a microwave communication signal shown as 209. Each transceiver is coupled into a node 201 to bridge between the nodes should fibre optic link 202a fail. As shown, when a break occurs in fibre optic cable 202a, then the microwave communication signal 209 is activated and users to the right of the break maintain connectivity to the wide area network.

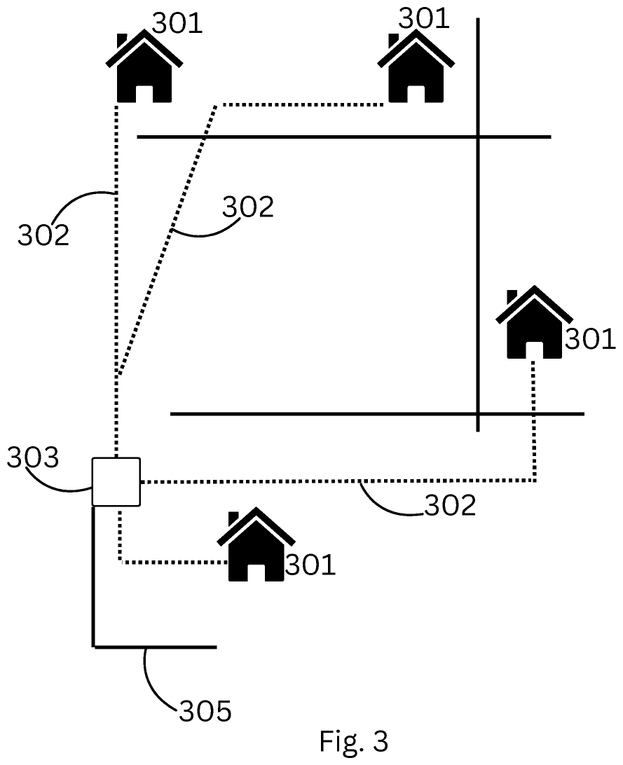

Referring to FIG. 3, shown is a remote area comprising homes 301 dispersed at significant distance, one from another and forming a community remote from other communities. In a situation such as this, there is often no wired Internet service available, no wired connection to the WAN. For a communication company to install internet services to each of the homes within the community, a cable 302—either a conductive wire or a fibre optic cable—is run from each home to a junction box. The junction box 303 serves as a local hub for the wired WAN connections. The communication company also installs a cable connection 305 to the junction box from the WAN, supporting Internet bandwidth for each home within the community. When a home subscribes to the service, their WAN connection is enabled for using the Internet.

As is evident, the cost of running physical connections to houses that are significantly spaced is high relative to a value of that specific customer. The cost of running a cable connection to a small community that is very remote, is also disproportionate to the value of the customers as a community.

One solution to the connectivity problem is to rely on satellite communication for providing connectivity. Though satellite communication can support remote communities, satellite is not always suitable, satellite connections are costly, and often the bandwidth supported by satellite communications exceeds a customer's needs or willingness to pay. Satellite latency makes performance more sluggish than is ideal. Further, installation and maintenance of satellite communication ground systems is not ideal for remote communities, which may be absent communication and networking specialists.

Finally, in larger remote communities, it is known to set up a community service provider—a utility company—that receives WAN signals either by cable or wirelessly and then acts to provide a local population with networking communication services. Such a utility model is common because of the high cost of connecting the remote community to the outside world and because of the high cost of connecting computers within the remote community to the Internet.

A more robust, less prone to failure, solution having lower maintenance costs would be advantageous for remote communities. A more robust, less prone to failure, solution would also be advantageous in case of serious catastrophe.

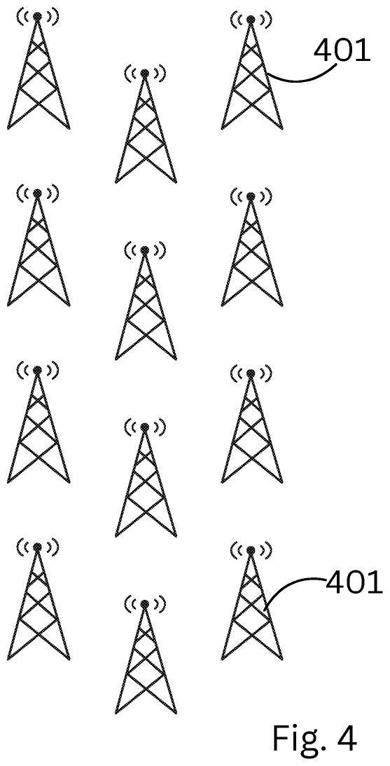

Referring to FIG. 4, shown is a plurality of TVWS transceivers disposed across a sparsely populated area, for example 30 miles apart. Each TVWS transceiver is coupled to a rechargeable battery for powering said transceiver. With M transceivers all operating in a listening mode and each of the M transceivers communicatively coupled to the Internet, fault tolerance in the network is achieved so long as each transceiver is positioned for communicating with at least two other transceivers, each with independent connections to the WAN. In FIG. 4, each transceiver is shown communicatively coupled to 4 or 6 transceivers, respectively, providing for multiple access pathways to each of several access points. Any of the M transceivers that are not wired into the infrastructure, would have an active transceiver sending out periodic signals—heartbeats comprising an ID, geolocation data and its available TVWS channels. In this way, each transceiver knows all its neighbors and all other transceivers through one hop relays.

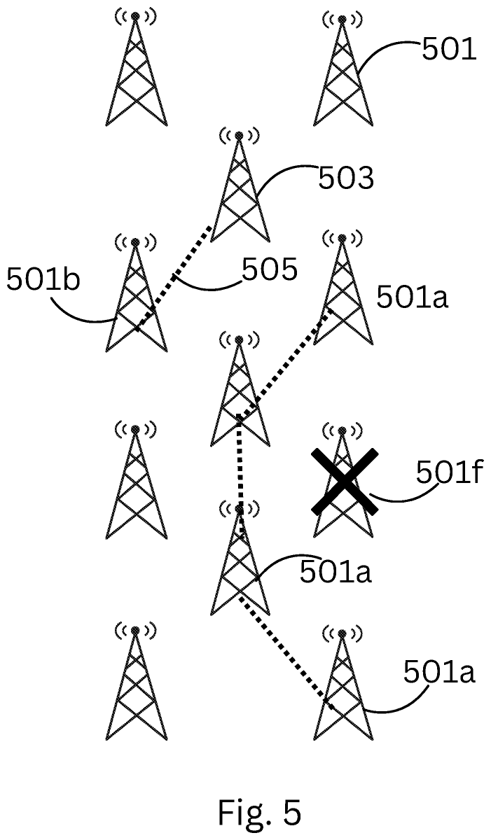

Referring to FIG. 5, shown is a plurality of transceivers 501 spanned over a large area. Here a single transceiver 501f is faulty or damaged. As is evident, when the transceiver 501f fails, other transceivers 501a have coverage over some of its area and are also able to act as a bridge around the failed transceiver 501f. Thus, the transceivers automatically reconfigure to provide service to the exclusion of transceiver 501f. For example, service is provided to user transceiver terminals (not shown) that are within range of the now active transceivers 501a.

Similarly, when a transceiver 503 is incapable of reaching the Internet via wired or wireless means, it sends out a signal indicating its disconnection situation and another transceiver 501b within communication range upon hearing this signal begins to transmit to that transceiver a signal 505 for supporting a link to the Internet. Over time, the network configures, or re-configures, to provide the transceiver with a connection to the Internet with a minimum or reasonable number of transmitting transceivers while the remainder remain in listening mode.

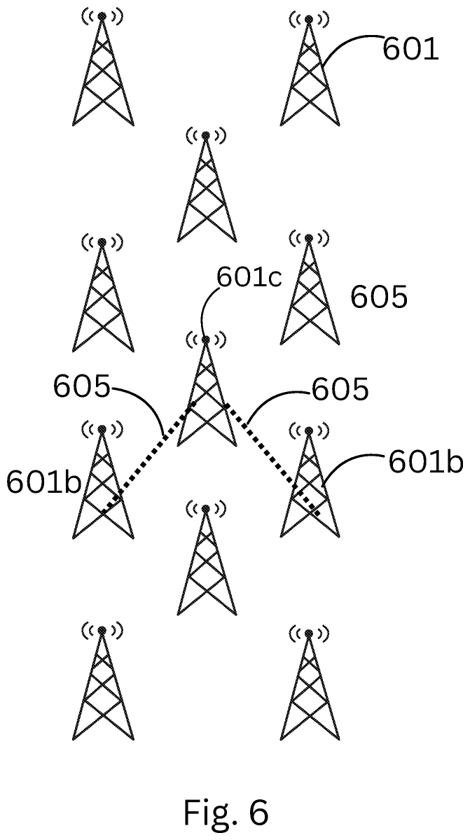

In a simplified diagram of an embodiment shown in FIG. 6, the transceivers cooperate to balance a load on each transceiver and for each terminal. When a transceiver fails or when connectivity to the WAN from transceiver 601c fails, terminals 601b act to provide WAN connectivity thereto via wireless signals 605 with less effect on each transceiver. In another embodiment, the terminals are serviced equally; in another embodiment, they are serviced unequally, for example based on a subscription type. Alternatively, the terminals are serviced based on a priority assigned to each. For example, a hospital and other emergency services is provided up to 90% of available bandwidth at all times and other terminals are apportioned their respective allocation when the emergency services are not consuming bandwidth or a lessor allocation when the bandwidth is being used by emergency services. Alternatively, another percentage of bandwidth is allocated to emergency services.

Thus, the network of transceivers reconfigures itself to wirelessly, via TVWS (TV white space), provide network connectivity to a transceiver 601c that cannot communicate with the Internet and to terminals in communication with said transceiver. By placing terminals, endpoint transceiver antennas, at select high priority locations—hospitals, military, police, government, health authorities, security establishment, schools, churches etc., the network effectively reconfigures to ensure that those transceivers nearly always are communicatively coupled to the Internet. Of course, the terminals optionally function as transceivers forming part of the overall M transceivers and some of them may be equipped with audio and sound capabilities to display or sound an alarm condition.

The resulting network supports all M transceivers having nearly 100% up time with a bandwidth of no worse than a single transceiver bandwidth divided by M but scaling linearly with a number of transceivers wirelessly connected together in a network, each from a single access point. With a small battery backup and solar panels/wind turbines and/or grid connectivity, the transceivers can form a network spanning thousands of kilometers to ensure that no single point of failure causes the overall communication network to fail and that Internet failure in general would require a statistically unlikely portion of an entire country to have no internet access. By spanning several chains of transceivers across the country, a wide area (for example along Canada's southern boarder) can have full coverage with multiple path redundancy (a failure of one transceiver would be bypassed along another chain). Though the bandwidth would be lower than 5G, emergency services like military, hospital, government, police, security, communications, etc. would be available. The network is sufficient for supporting a broad SMS and text-based email communication network similar to the original Blackberry® network. Further, by connecting the transceivers to cellular communications infrastructure by physical wire, some level of dynamically configurable (or static) communication network is supported around each cellular transceiver without adopting special purpose hardware.

In some embodiments, transceivers are uniform—a box with a transceiver, a battery, a solar/wind generator, a plug, and a few network output ports and could be installed physically on those priority locations. The transceiver is pre-designed and configured to reach R km where R is the longest distance between any two points within the designated coverage area. Therefore, the deployed local network for average sized town/city/county can be guaranteed that every pair of transceivers can establish a communication link within maximum one relayed transceiver. Thus, every pair TVWS devices can talk and see each other either directly or need help by another middle device only. Alternatively, transceivers are configured to operate at radius R km when in normal operating mode and at radius R2 km, further than R km, during emergency operation.

Such local networks can be amalgamated into a large network to provide a robust connectivity across a country or continent. Further, when the areas are more densely populated, there is likely to be more endpoint communication transceivers rendering the network even more robust (anti-fragile).

Advantageously, the wireless network of FIG. 4 is also operable to provide network connectivity to remote communities within range of the transceivers that are outside wired network connectivity and cellular network connectivity.

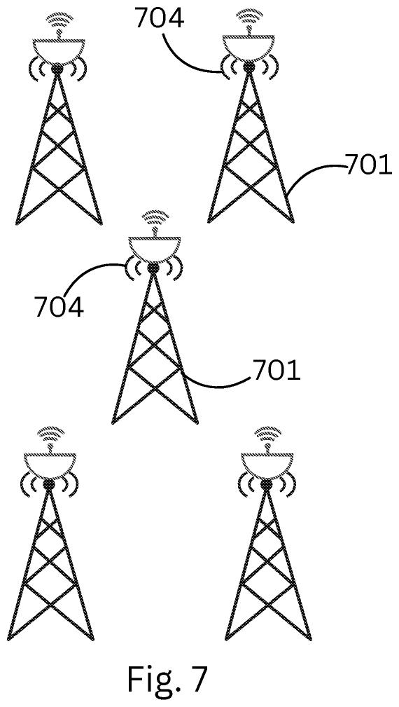

Referring to FIG. 7, shown is a similar network to that of FIG. 4, but with each TVWS transceiver 701 connected to a WAN in the form of the Internet via satellite communications. Here, each transceiver 701 is communicatively coupled to a satellite transceiver 704 for communication with the Internet. Failure of a satellite transceiver, a transceiver, or a connection therebetween results in network reconfiguration to maintain network connectivity.

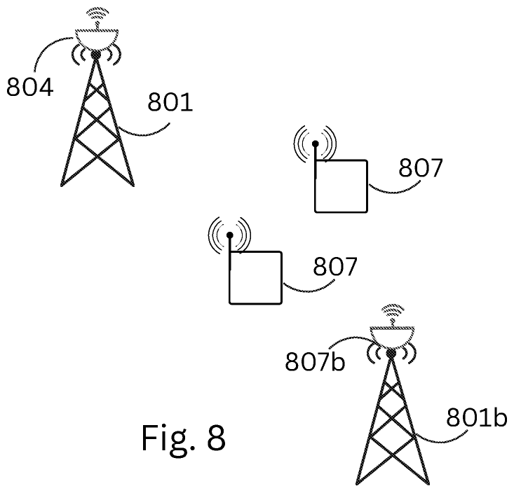

Referring to FIG. 8, shown is a single transceiver 801 connected to a WAN in the form of the Internet via satellite communications. Here, the transceiver 801 is communicatively coupled to a satellite transceiver 804 for communication with the Internet. The transceiver 801 then supports communication via the WAN from any number of terminals 807 within range thereof. Thus, a single transceiver 801 with satellite Internet is able to provide Internet communications to a small sparsely populated remote community such as that of FIG. 3. Advantageously, a second transceiver 801b coupled with a second satellite transceiver 807b and having satellite communication when disposed in an overlapping area provides fault tolerance for the communications of the community.

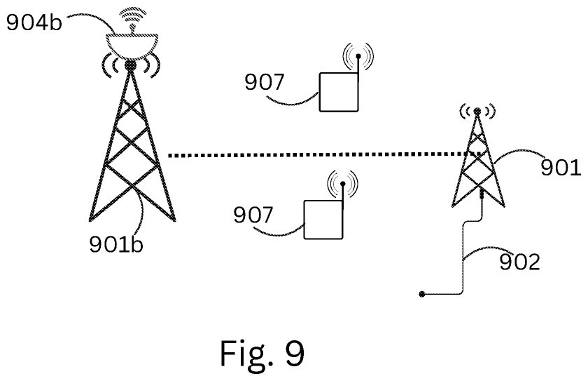

Referring to FIG. 9, shown is a single transceiver 901 on one side of a valley is close enough to existing infrastructure to be communicatively coupled, via cable 902, with the WAN in the form of the Internet. Here, the transceiver 901 supports community communication with the Internet. The transceiver 901 then supports communication via the WAN from any number of terminals 907 within range thereof. Thus, a single transceiver with Internet connectivity is able to provide Internet communications to a small sparsely populated remote community such as that of FIG. 3. Advantageously, a second transceiver 901b coupled to a satellite transceiver 904b in an overlapping area provides fault tolerance for the communications of the community such that failure of both of two separate methods of communication results in network communication failure. For example, when one transceiver fails, a signal is transmitted between the two transceivers 901 and 901b (shown in dashed line) to share the WAN communications between each of the two transceivers. 901 and 901b

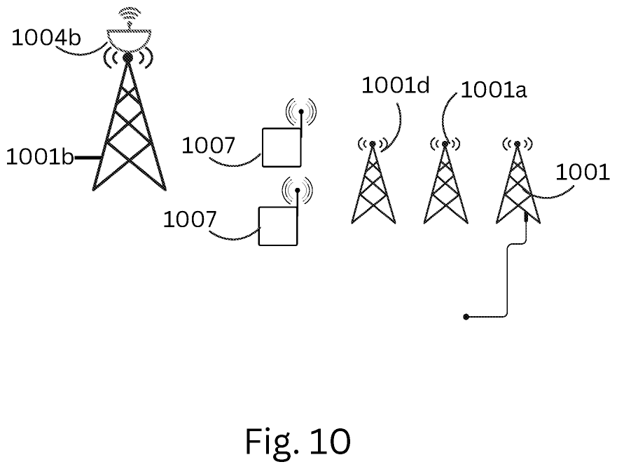

Referring to FIG. 10, shown is a single transceiver 1001d connected to a WAN in the form of the Internet via TVWS communications. Here a transceiver 1001d on one side of a valley is communicatively coupled to a series of transceivers 1001a with the last 1001n of the series of transceivers close enough to existing infrastructure to be communicatively coupled, either via cable or via wireless communication, with the WAN in the form of the Internet. Here, the transceiver 1001d supports community communication with the Internet. The transceiver 1001d then supports communication via the WAN from any number of terminals 1007 within range thereof. Thus, a single transceiver 1001d with Internet connectivity is able to provide Internet communications to a small sparsely populated remote community such as that of FIG. 3. Advantageously, a second transceiver 1001b with a satellite communication transceiver 1004b in an overlapping area provides fault tolerance for the communications of the community such that failure of both of two separate routes of communication results in network communication failure. Of course, many fault tolerant network topologies are supported.

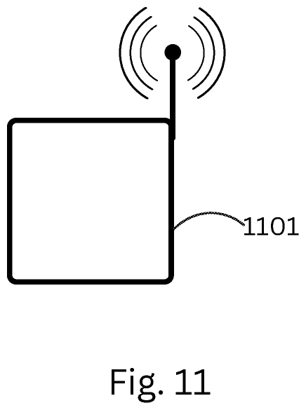

Referring to FIG. 11, shown is a self-configuring network communication transceiver unit 1101. The self-configuring network communication transceiver unit upon installation determines available TVWS channels for transmitting and receiving signals; remote transceivers that are within range and whether they are a source of network access, a user of network access, or both; terminals within range of the transceiver and whether they are uniquely communicatively coupled to the transceiver or whether they are communicatively coupled to multiple transceivers.

When terminals are communicatively coupled to multiple transceivers, their bandwidth load on the network is balanced within the communication network to allocate to each terminal an appropriate bandwidth allocation. Each access routing to the WAN is identified to allow switching and automatic adjustment of network topology in response to new terminal installation, new transceiver installation, network failure, etc.

Exemplary applications of the transceivers of FIG. 11 are now described. In a first embodiment, a transceiver supports 5 Mb of bandwidth with each of 20 terminals in communication therewith. When a 21^{st} terminal is installed, a second transceiver is installed resulting in each of the 21 terminals having approximately 10 Mb of bandwidth using one transceiver supporting more terminals and therefore a lower bandwidth to each terminal. Thus, each terminal receives less bandwidth with the installation of another terminal until a new transceiver is installed covering an area of approximately half the terminals. Such a network topology allows for transceivers to be added incrementally to support increased utilisation.

In another embodiment, a transceiver fails and the terminals communicated via that transceiver are rerouted to other transceivers resulting in lowed bandwidth, but maintaining network connectivity. For remote communities, lower bandwidth is often preferred to no bandwidth or communication interruptions.

In another embodiment, upon failure of network communication for one community, network access is shared with another community that is sufficiently close to allow bandwidth sharing. Here, for example, the nearby community gives up 100 Mb of its bandwidth or half of its bandwidth (whichever is less) for their neighbours. Of course, if there are two close communities, it is possible to either borrow 100 Mb from each or to borrow 100 Mb total part from each to replace network communications during the outage.

In another embodiment, a community is relying on satellite communications. When weather interrupts the communication with the satellite, the community is provided a temporary bandwidth allocation from one or more nearby communities or from a nearby satellite receiver that is not suffering similar weather-related outages. As transceivers can be spaced at quite a distance, with 6 transceivers and 3 satellite transceivers, the community can have three satellite receivers available and spaced well over 100 km from one end to the other. This allows for triple redundancy on network communication with additional bandwidth available when all satellite transceivers are available, should that be desired.

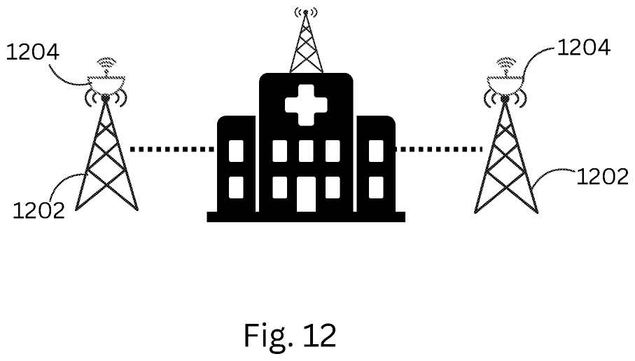

Referring to FIG. 12, shown is a single transceiver connected to a WAN in the form of the Internet via TVWS communications. Here the transceiver 1201 has a communication link to the Internet. The transceiver 1201 also supports paid connectivity to the Internet, therethrough. A local household installs a terminal 1207, connects to the transceiver 1201 and is prompted to pay for connectivity. Once payment is processed, the transceiver 1201 reconfigures to allocate bandwidth in accordance with the payment to the terminal. In such a network topology, the transceiver 1201 is optionally owned by the community with payments going to offset community expenses such as the transceiver and connectivity costs. Alternatively, the transceiver 1201 is owned by an individual who, without any networking experience, sells bandwidth to their neighbours in any of a number of different models including hourly, monthly, based on bandwidth utilisation, based on time of day, etc. For example, a medical clinic in a remote community installs satellite internet with 3 transceivers with the transceiver 1201 at the clinic and two other transceivers 1202 disposed remotely each with a satellite transceiver 1204 for providing a secondary connection to the network for fault tolerance. The cost of the entire system is approximately $3,000 plus $400/mo for duplicated network connectivity. If the clinic then allows terminals to connect via the clinic's transceiver to the WAN, with 10 subscriber connections at $30/month, the clinic recovers much of its ongoing expenses and still has capacity to offer 10 more connections without significantly affecting clinic bandwidth. Thus, the clinic, which needed reliable connectivity, can offset its costs with little effort while supporting their local remote community.

If the clinic only offers full bandwidth after hours, when the clinic no longer needs connectivity, then the clinic can sell all of its after-hour bandwidth and maintain high reliability high bandwidth as needed. Further, when subscribers are set to a lower priority, it remains possible to support their wide area network communication at a lower priority and without interfering with clinic communication requirements.

When a transceiver is also equipped with a dedicated power source in the form of a solar panel or a wind turbine and a battery, the transceiver is easily deployed in remote locations to provide local communication across a large area in an automated fashion, either for acting as a utility or for supporting a community or individuals remote from their community. The simplicity of installation of a system with a dedicated power source also allows deployment between hard wired transceivers or along a path from a hardwired transceiver to a remote community.

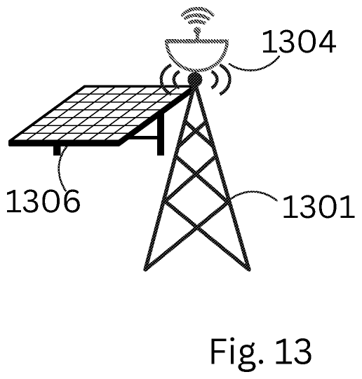

Referring to FIG. 13, in some embodiments, a self-powered transceiver 1301 is installed remotely as a communication hub or as a communication backup that is to be used only in the event of a network failure. Shown in FIG. 13, is a self-powered transceiver for emergency deployment. The transceiver 1301 is coupled to a satellite transceiver 1304 and to a power module 1306 comprising solar panels and a rechargeable battery. Thus, the transceiver 1301 is self-powering and does not require wires to communicate with the wide area network.

When used for instances of network failure, the transceiver 1301 transmits a heartbeat signal regularly to establish that it is functional and functioning, when in standby mode. When a transceiver heartbeat signal is other than received, the transceiver is noted as inoperative and requiring maintenance. The network viability, the ability to route without the inoperative transceiver is also noted to determine a priority of the required maintenance.

In some instances, the transceiver 1301 is used to bridge between wired networks in the case of a failure therebetween. For example, two remote communities are connected via a series of transceivers 1301 such that when one community loses Internet connectivity, the transceivers 1301 activate and form a communications bridge between the two communities to share communication bandwidth therebetween.

In another instance, the transceiver 1301 is used to create a temporary local area network without Internet connectivity. Optionally, such a transceiver is absent a satellite transceiver 1304.

In an embodiment, when a link between the two separate wired networks is severed, the self-powered transceivers begin communication and an emergency link between the two wired networks is deployed. The first transceiver receives messages on the first data network and transmits them via TVWS to the second transceiver bound for the second network. When the network breach is repaired, the wired link is restored, the two transceivers are deactivated and maintained in their standby state awaiting another network failure.

Of course, with numerous transceivers, there is a standby transceiver network to link different data network segments in the case that they are separated due to a networking failure. By selectively placing the transceivers to bridge sub-networks that have a likelihood of being separated, network stability and availability are increased. Further, common routing and load balancing processes are employable when more than one wireless bridge is deployed to an isolated wired network.

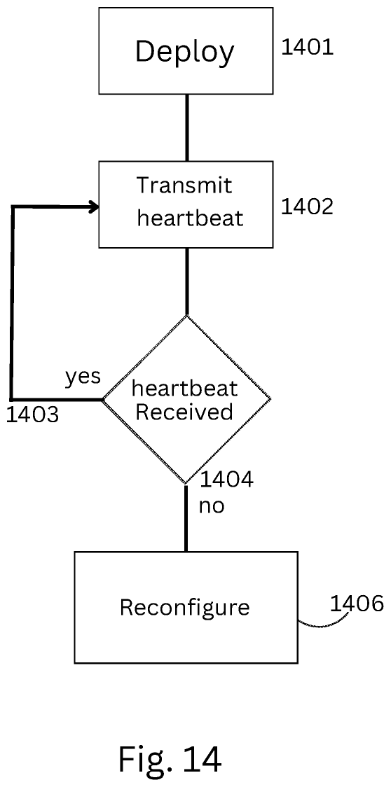

Referring to FIG. 14, shown is a simplified flow diagram of a process for a transceiver in stand-by mode. At 1401, transceiver is activated. Typically, this involves removing the transceiver from its packaging and assembling the parts. Once assembled, the transceiver is operational. The transceiver listens for control signals.

At 1402, the transceiver transmits a heartbeat. Transceivers within range of the transceiver respond with a heartbeat acknowledge signal. The transceiver registers all transceivers from which a heartbeat acknowledge signal is received. The transceiver then reverts to listening mode for a period of time until it is due to send out another heartbeat signal. In many applications heartbeat signals are transmitted infrequently, such as hourly.

At 1403, the transceiver receives a heartbeat from a nearby transceiver. The transceiver responds with a heartbeat acknowledge signal.

At 1404, the transceiver transmits a heartbeat signal and fails to receive a heartbeat acknowledge signal, indicating that there is no TVWS communication from the transceiver. The transceiver continues to operate in standby mode in the hopes of eventually receiving a heartbeat acknowledge signal. If the transceiver is coupled to the Internet by cable or by satellite, it reports all changes in status to allow a network control centre to respond to issues as they arise—for example if the transceiver is faulty and not registering a heartbeat acknowledge signal that is received or if the transceiver is failing to transmit.

At 1405 the transceiver reconfigures in accordance with the failed heartbeat.

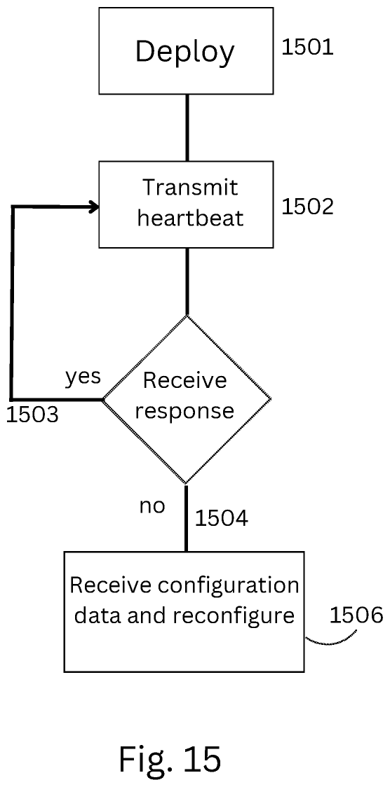

Referring to FIG. 15, shown is a simplified flow diagram of a process for a transceiver in stand-by mode responding to a central control. At 1501, transceiver is activated. Typically, this involves removing the transceiver from its packaging and assembling the parts. Once assembled, the transceiver is operational. The transceiver listens for control signals.

At 1502, the transceiver transmits a heartbeat to the central control. Transceivers within range of the transceiver respond with a heartbeat acknowledge signal. The transceiver registers all transceivers from which a heartbeat acknowledge signal is received. The transceiver then reverts to listening mode for a period of time until it is due to send out another heartbeat signal. In many applications heartbeat signals are transmitted infrequently, such as hourly.

At 1503, the transceiver receives a heartbeat from a nearby transceiver. The transceiver responds with a heartbeat acknowledge signal. The transceiver also includes an indication of every heartbeat and every heartbeat acknowledge signal it received between heartbeats in its next heartbeat signal.

At 1504, the transceiver transmits another heartbeat signal including data relating to all received heartbeat signals from surrounding transceivers, but this time it fails to receive a heartbeat acknowledge signal, indicating that there is no TVWS communication from the transceiver. The transceiver continues to operate in standby mode in the hopes of eventually receiving a heartbeat acknowledge signal. If the transceiver is coupled to the Internet by cable or by satellite, it reports all changes in status to allow a network control centre to respond to issues as they arise—for example if the transceiver is faulty and not registering a heartbeat acknowledge signal that is received or if the transceiver is failing to transmit.

At 1506 the transceiver receives reconfiguration data from the central control and reconfigures in accordance with the reconfiguration data.

In a more detailed description of the network of FIG. 15, a self-arranging network based on TVWS communication is provided. Here, each TVWS transceiver transmits a heartbeat signal at intervals. Each heartbeat signal indicates a transmitting transceiver and all the transceivers from which the transceiver has received heartbeat signals. In theory, each transceiver receives a number of heartbeats including a self-reference as when all transceiver hardware is the same and is configured the same, a transceiver signal is received by transceivers from which a signal is received. Thus, in a deployment of this type, each transceiver knows the transceivers that they communicate with directly and all transceivers that they communicate with via another node. In essence, a network map is formable for two hops—an adjacent transceiver and a transceiver adjacent to an adjacent transceiver in all directions.

When the heartbeat from each transceiver is provided to a central processor having a physical topology of the transceiver network, the central processor determines a wireless communication routing involving some or all of the wireless transceivers. In some situations, only a path from one access point to another is required and only transceivers along that path are enabled. In other applications those transceivers and transceivers wirelessly coupled to user terminals are enabled. In yet other applications, a plurality of transceivers is enabled including several communication paths.

Once the network configuration is configured, the central processor optionally determines permissible traffic based on bandwidth limitations imposed by the physical constraints of the network. For example, if 100,000 homes are to be supported via a TVWS wireless connection between wired networks, the bandwidth for each home will be small, on average, and the processor may limit traffic to text and SMS, filtering out access to YouTube®, for example. Alternatively, if only 10 homes are to be supported via a TVWS wireless connection, the processor need not restrict access, but may prioritise traffic.

Numerous other embodiments may be envisaged without departing from the scope of the invention.

What is claimed is:

1. A method comprising:
providing a first transceiver for transmitting and receiving signals within a television portion of the spectrum, the transceiver for operating within the television white space band;
operating the first transceiver in a standby mode wherein at intervals the transceiver transmits within the television white space band a heartbeat signal and awaits a heartbeat acknowledgement signal within the television white space band; and
upon receiving a heartbeat acknowledgement signal in response to a transmitted heartbeat signal, performing at least one of storing an indication of a transceiver from which the heartbeat acknowledgement signal is received and transmitting an indication of the transceiver from which the heartbeat acknowledgement signal is received to a remote server.

2. A method according to claim 1 wherein heartbeat signals are transmitted form the first transceiver at intervals no shorter than one minute.

3. A method according to claim 1 wherein in response to other than receiving a heartbeat acknowledgement signal within the television white space band, reconfiguring operation of the first transceiver.

4. A method according to claim 1 wherein in response to other than receiving a heartbeat acknowledgement signal within the television white space band, transmitting an error indication to the remote server.

5. A method according to claim 1 wherein in response to receiving a heartbeat acknowledgement signal within the television white space band, returning to standby mode for an interval until another heartbeat signal is to be transmitted, in standby mode the transceiver listening for signals directed thereto and for heartbeat signals.

6. A method according to claim 1 wherein the first transceiver receives at least two heartbeat acknowledgement signals within the television white space band and stores data relating to each transceiver from which the heartbeat acknowledgement signal was received.

7. A method according to claim 6 wherein upon transmitting a subsequent heartbeat signal, the first transceiver transmits an error message to a remote server when fewer heartbeat acknowledge signals are received than in a previous iteration, the error message including a list of transceivers from which a heartbeat acknowledge signal is received.

8. A method according to claim 1 wherein the first transceiver receives at least two heartbeat acknowledgement signals within the television white space band and compares transceivers from which a heartbeat acknowledge signal is received against data relating to each transceiver from which the heartbeat acknowledgement signal was previously received; and
when there is a change in the transceivers from which a heartbeat acknowledge signal is received, the change showing fewer transceivers than before, automatically reconfiguring communication from the first transceiver to compensate for failure of at least a missing transceiver.

9. A system comprising:
a first transceiver for operation within the television white space band for transmitting and receiving signals within the television whitespace band;
a heartbeat signal circuit for transmitting at intervals a heartbeat signal from the first transceiver and for receiving heartbeat acknowledgement signals in response thereto; and
a heartbeat acknowledgement signal circuit for in response to receiving a heartbeat signal transmitting a heartbeat acknowledgement signal, the heartbeat acknowledgement signal including data for identifying the first transceiver.

10. The system of claim 9 comprising a dedicated power source.

11. The system according to claim 10 comprising a repeater circuit for receiving a signal from one transceiver and transmitting at least a portion of the information within the signal to another different transceiver.

12. The system according to claim 10 comprising a repeater circuit for receiving a signal from one transceiver and transmitting all of the information within the signal to another different transceiver.

13. The system according to claim 12 comprising:
a fault detection circuit for determining a failure of another transceiver and for changing operation of the first transceiver in response to a detected failure to maintain network connectivity.

14. The system according to claim 1 comprising:
a bandwidth detection circuit for determining a balance of bandwidth between transceivers having overlapping areas of transmission and for changing operation of the first transceiver in order to balance bandwidth availability from the first transceiver and among systems communicatively coupled therewith for receiving data networking therefrom.

15. The system according to claim 9 comprising:
a bandwidth detection circuit for determining a balance of bandwidth between transceivers having overlapping areas of transmission and for changing operation of the first transceiver in order to balance bandwidth availability from the first transceiver and among systems communicatively coupled therewith for receiving data networking therefrom.

16. A method comprising:
providing a first transceiver for transmitting and receiving signals within a television portion of the spectrum, the transceiver for operating within the television white space band;
operating the first transceiver in a standby mode wherein at intervals the transceiver transmits within the television white space band a heartbeat signal and awaits a heartbeat acknowledgement signal within the television white space band; and
upon receiving a heartbeat acknowledgement signal in response to a transmitted heartbeat signal, performing one of storing an indication of a transceiver from which the heartbeat acknowledgement signal is received and transmitting an indication of a transceiver from which the heartbeat acknowledgement signal is received to a remote server.

17. A method according to claim 16 comprising:
upon other than receiving a heartbeat acknowledgement signal, transmitting a signal to the remote server.

18. A method according to claim 16 wherein the heartbeat and acknowledgement comprise wireless signals transmitted, the wireless signals comprising a unique sequence related to a digital identifier of the first transceiver.

19. A method according to claim 16 wherein the first transceiver is communicatively coupled for communication via the Internet.

20. A method according to claim 16 wherein acknowledgements come from other similar transceivers, some acting as bridges while others having direct communicative access to data via the Internet.
